(19) United States
(12) Patent Application Publication
(10) Pub. No.: US 2008/0252729 A1
(43) Pub. Date: Oct. 16, 2008

(54) ADVANCED BIRD VIEW VISUAL SYSTEM

(75) Inventors: Chui-Fan Chiu, Taoyuan Hsien (TW); Chun-Chieh Wang, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/968,339

(22) Filed: Jan. 2, 2008

(30) Foreign Application Priority Data
Jan. 3, 2007 (TW) 096100255

(51) Int. Cl. H04N 7/18

(52) U.S. Cl. 348/148

(57) ABSTRACT

A bird view visual system for a vehicle is provided. The bird view visual system for the vehicle includes a plurality of image sensors disposed around the vehicle for monitoring the environment around the vehicle and a plurality of bases for mounting the respective image sensors. Each of the bases further includes an adjustable apparatus adjusting a viewing angle of the respective image sensor, the viewing angle is ranged between 35 and 90 degree with respective to a vertical line.

### FIELD OF THE INVENTION

The present invention relates to a bird view visual system, and more particularly to a bird view visual system having an adjustable viewable range.

### BACKGROUND OF THE INVENTION

In recent decades, with the vigorous developments of the optical display technology, it becomes a trend in the automobile industry that more and more vehicles are equipped with the navigation system having the accurate and rapid image retrieving and displaying. The navigation system provides the information regarding where the vehicle is located and/or the surrounding environments of the vehicle, and shows such information to the driver and/or the passenger via a monitor. In general, the navigation system according to the prior art is combined with a global positioning system (GPS), which supplies the real-time location information of the moving vehicle through a satellite signal receiver, so that the GPS combining with a database of map can be used as a satellite navigation system for the vehicle. Besides the navigation system in connection with the GPS, a further innovative navigation system, i.e. the bird view visual system that provides the real time information of the surrounding environment of the vehicle is often equipped on the vehicle. The known bird view visual systems provide the images regarding the surrounding of the vehicle to the driver by one or more image sensor(s) disposed around the vehicle, wherein the image sensor captures the images regarding two meters around the vehicle so that the driver can steer the car in a safer way in accordance therewith.

Please refer to FIGS. 1A and 1B, which schematically show the general bird view visual system according to the prior art. As shown in FIG. 1A, the bird view visual system 100 includes four image sensors 101A-101D, which are mounted at a front side, a back side, a right side and a left side of the vehicle for monitoring the environment information around the vehicle.

The image sensor of the known bird view visual system is designed for preventing the vehicle from colliding with the object near or approaching thereto. In general, the collisions of the vehicle usually happen on the situation of parking, driving in the narrow stresses or car meeting. Therefore, the known bird view visual system mainly design for providing the information within two meter around the vehicle in order that the driver can steer the car more safely according to the information provided by the bird view visual system. Nevertheless, because most of the known bird view visual systems are designed only for avoiding the possible collisions on the particular driving situations, most of the known bird view visual systems usually only monitor the images around the height of the bumper of the vehicle. Furthermore, in order to prevent the vehicle from colliding with the sidewalk or the median barrier of the road, which is usually regarded as the possible invisible regions to the driver, the known bird view visual systems usually monitor the environment information of the vehicle with a fixed declined angle in order to monitor the possible invisible regions to the driver, i.e. the environment within two meters around the vehicle, as shown in the regions denoted by A, B, and C of FIG. 1B.

However, the known bird view visual systems are limited by the above characteristics instead. The viewable ranges of the known bird view visual systems are limited and thus such the bird view visual systems are only applicable to the driving situations of lower speed. So, when the vehicle is steered at a normal driving speed, the known bird view visual system equipped therewith is inefficient because the viewable range are such limited. Therefore, it is necessary to develop a novel bird view visual system having a relatively larger viewable range for providing the more accurate information to the driver.

### SUMMARY OF THE INVENTION

In accordance with one aspect of the present invention, a bird view visual system mounted on a vehicle is provided. The system includes a plurality of image sensors disposed around the vehicle for monitoring an environment change around the vehicle, and a plurality of bases mounting the respective image sensors, wherein each of the bases further comprises an adjustable apparatus adjusting a viewing angle of the respective image sensor, and the viewing angle is ranged from 35 to 90 degree with respective to a vertical line.

Preferably, the plurality of image sensors are four image sensors.

Preferably, the four image sensors are respectively mounted at a front side, a back side, a right side and a left side of the vehicle.

Preferably, the adjustable apparatus is an angle adjusting device for adjusting the viewing angle of each the respective image sensor.

Preferably, the adjustable apparatus is an optical lens set for adjusting the viewing angle of each respective image sensor.

Preferably, the optical lens set is one of a refractive lens set and a reflective lens set.

In accordance with another aspect of the present invention, a bird view visual system mounted on a vehicle is provided. The system includes a plurality of image sensors disposed around the vehicle for monitoring an environment change around the vehicle, and a plurality of bases mounting the respective image sensors, wherein each of the bases further comprises an adjustable apparatus adjusting a viewable range of the respective image sensor.

Preferably, the plurality of image sensors are four image sensors.

Preferably, the four image sensors are respectively mounted at a front side, a back side, a right side and a left side of the vehicle.

Preferably, the adjustable apparatus is an angle adjusting apparatus for adjusting a viewing angle of each respective image sensor.

Preferably, the adjustable device is an optical lens set for adjusting a viewing angle of each the respective image sensor.

In accordance with a further aspect of the present invention, a method for adjusting a viewable range of a bird view visual system for a vehicle is provided. The method includes the steps of disposing a plurality of image sensors around the vehicle, and adjusting the respective viewing angles of the image sensors so as to monitor an environment change around the vehicle.

Preferably, the plurality of image sensors are four image sensors respectively mounted at the front site, the back site, the right site and the left site of the vehicle.

Preferably, the viewing angle of each image sensor is adjusted by a mechanical device.

Preferably, the viewing angle of each image sensor is adjusted by an optical device.

Preferably, the optical device is one of a refractive lens set and a reflective lens.

Preferably, each of the sensors further includes a base, through which the respective image sensor is mounted thereon.

Preferably, each of the bases further includes an adjustable apparatus, through which the viewing angle of the respective image sensor is adjustable.

### BRIEF DESCRIPTION OF THE DRAWINGS

FIG. 1A and FIG. 1B schematically show a bird view visual system according to the prior art.

FIG. 2 schematically shows a bird view visual system according to a preferable embodiment of the present application.

FIG. 3 schematically shows an image sensor mounted on a vehicle of a bird view visual system according to a preferable embodiment of the present application.

FIG. 4A and FIG. 4B schematically shows the viewing angles of the bird view visual system of present application at a low driving speed and at a high driving speed respectively.

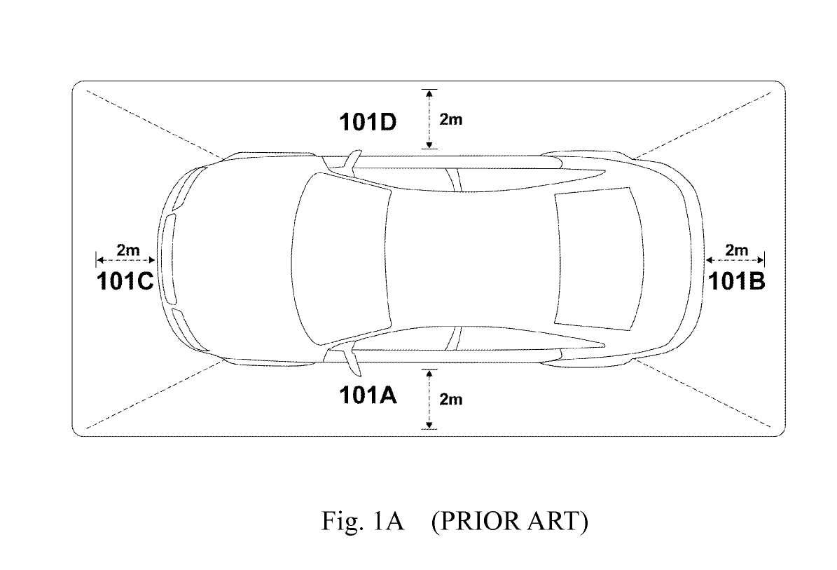

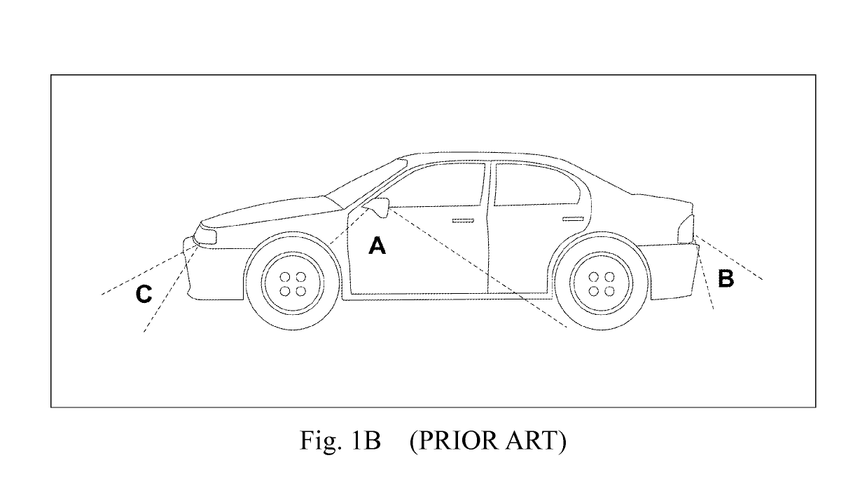

### DETAILED DESCRIPTION OF THE PREFERRED EMBODIMENT

In order to further illustrate the techniques, methods and efficiencies used to procure the aims of this invention, please see the following detailed descriptions. It is believable that the features and characteristics of this invention can be deeply and specifically understood by the descriptions. It is to be noted that the following descriptions of preferred embodiments of this invention are presented herein for the purposes of illustration and description only; it is not intended to be exhaustive or to be limited to the precise form disclosed.

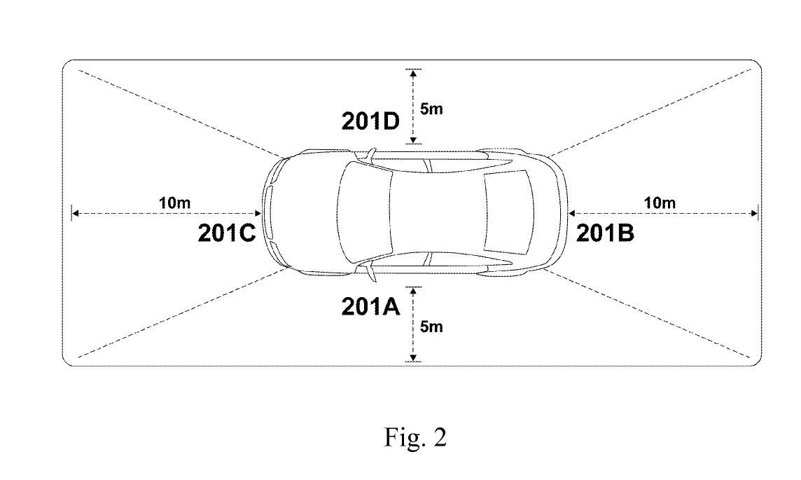

Please refer to FIG. 2, which schematically shows a bird view visual system for a vehicle according to a preferred embodiment of the present application. As shown in FIG. 2, the bird view visual system 200 includes four image sensors mounted around the vehicle respectively. The main difference between the bird view visual system 200 and the bird view visual systems according to the prior art is that the four image sensors of the bird view visual system according to the prior art are mounted on the vehicle with a fixed angle, while the image sensors of bird view visual system 200 are mounted on the vehicle through the respective bases having a adjustable apparatus adjusting a viewable range of the respective image sensor.

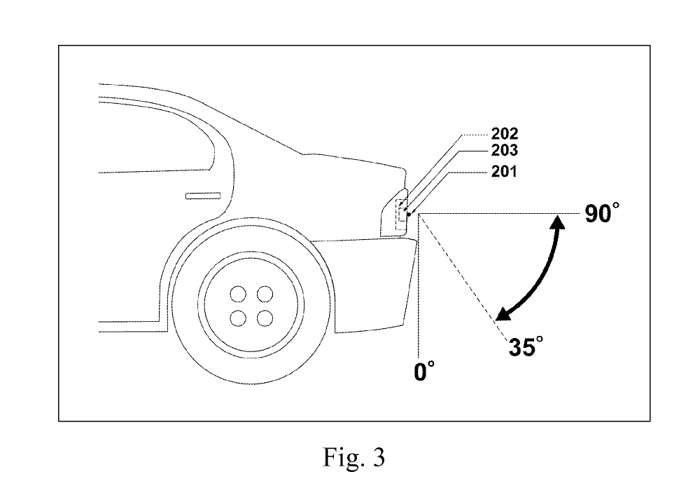

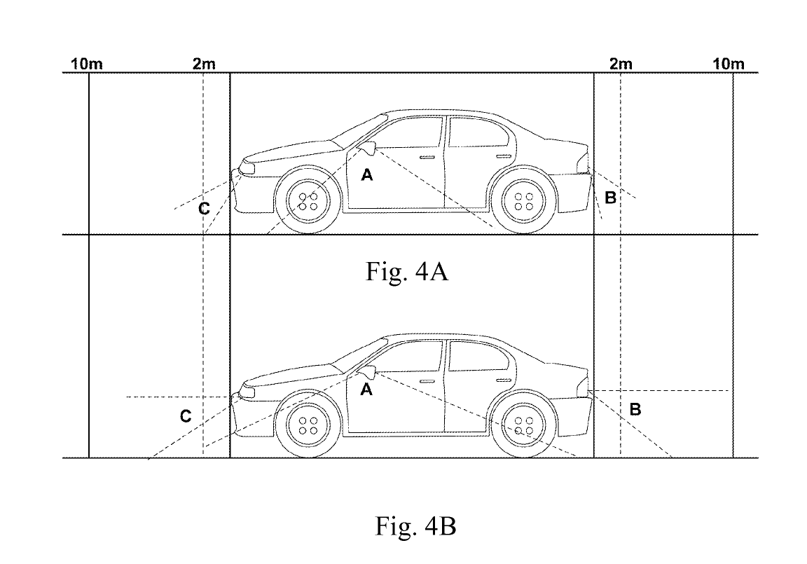

Please refer to FIG. 3, which exemplarily illustrates the arrangement of one of the image sensors of bird view visual system 200 mounting on a vehicle. As shown in FIG. 3, the image sensor 201 mounts on the vehicle by a base 202, wherein the base 202 further includes an adjusting apparatus 203. In a preferable embodiment of the present invention, a viewing angle of the image sensor 201 is ranged from 35 to 90 degree with respective to a vertical line. Please further refer to FIGS. 4A and 4B, which schematically show the viewing angles of the bird view visual system of present application at a low driving speed and at a high driving speed respectively. When the vehicle moves at the relatively low driving speed, such as the situation of parking the car or the situation of the car meeting in a narrow lane, the bird view visual system 200 can monitors the environment around the vehicle within two meters around the vehicle with a declined viewing angle, as shown in FIG. 4A. On the other hand, when the vehicle moves at a relatively high driving speed, the viewing angle of the bird view visual system 200 can be adjusted to a 90 degree with respective to a vertical line by the adjusting apparatus 203, so that the viewable range increases to over ten meters around the vehicle. Therefore, the bird view visual system 200 can provides different viewable range of the images regarding the environment information around the vehicle, so that the bird view visual system of the present invention is applicable to both of the situations that the car are driven at the relatively low driving speed and at the relatively high driving speed.

Moreover, although the base 202 of bird view visual system 200 according to the present invention are incorporated with an adjusted apparatus 203 for adjusting the viewing angle of the image sensor, it should be pointed out that the design and the arrangement of the base 202 of bird view visual system 200 are compatible with the known bird view visual systems, and thus the design and assembly cost of bird view visual system 200 would not be much increased. Further, it also should be noted that the adjusted apparatus 203 can not only be controlled by a mechanical angle adjusting device, but also can be controlled by an optical lens set. Specifically, the viewing angle of the image sensor 201 can also be adjusted by a refractive lens set and a reflective lens set

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A bird view visual system for a vehicle, comprising:
a plurality of image sensors disposed around the vehicle for monitoring the an environment change around the vehicle; and
a plurality of bases mounting the respective image sensors,
wherein each of the bases further comprises an adjustable apparatus adjusting a viewing angle of the respective image sensor, wherein the viewing angle is ranged between 35 and 90 degree with respective to a vertical line.

2. A system according to claim 1, wherein the plurality of image sensors are four image sensors.

3. A system according to claim 2, wherein the four image sensors are respectively mounted at a front side, a back side, a right side and a left side of the vehicle.

4. A system according to claim 1, wherein the adjustable apparatus is an angle adjusting device for adjusting the viewing angle of each the respective image sensor.

5. A system according to claim 1, wherein the adjustable apparatus is an optical lens set for adjusting the viewing angle of each respective image sensor.

6. A system according to claim 5, wherein the optical lens set is one of a refractive lens set and a reflective lens set.

7. A bird view visual system for a vehicle, comprising:
a plurality of image sensors disposed around the vehicle for monitoring an environment change around the vehicle; and
a plurality of bases mounting the respective image sensors,
wherein each of the bases further comprises an adjustable apparatus adjusting a viewable range of the respective image sensor.

8. A system according to claim 7, wherein the plurality of image sensors are four image sensors.

9. A system according to claim 8, wherein the four image sensors are respectively mounted at a front side, a back side, a right side and a left side of the vehicle.

10. A system according to claim 7, wherein the adjustable apparatus is an angle adjusting apparatus for adjusting a viewing angle of each respective image sensor.

11. A system according to claim 7, wherein the adjustable device is an optical lens set for adjusting a viewing angle of each the respective image sensor.

12. A method for adjusting a viewable range of a bird view visual system for a vehicle, comprising:
(a) disposing a plurality of image sensors around the vehicle; and
(b) adjusting the respective viewing angles of the image sensors so as to monitor an environment change around the vehicle.

13. A method according to claim 12, wherein the plurality of image sensors are four image sensors respectively mounted at the front site, the back site, the right site and the left site of the vehicle.

14. A method according to claim 12, wherein the viewing angle of each image sensor is adjusted by a mechanical device.

15. A method according to claim 12, wherein the viewing angle of each image sensor is adjusted by an optical device.

16. A method according to claim 15, wherein the optical device is one of a refractive lens set and a reflective lens.

17. A method according to claim 12, wherein each of the sensors further comprises a base, through which the respective image sensor is mounted thereon.

18. A method according to claim 17, wherein the bases further comprises an adjustable apparatus, through which the viewing angle of the respective image sensor is adjustable.
